(19) United States
(12) Patent Application Publication
(10) Pub. No.: US 2023/0241567 A1
(43) Pub. Date: Aug. 3, 2023

(54) CAPSULE, DEVICE AND METHOD FOR MIXING MULTIPLE SUBSTANCES

(71) Applicant: Capsulab Ltd, Ramat Gan (IL)

(72) Inventors: Dov MEERZON, Even Yehuda (IL); Gal SAAR, Shoham (IL)

(73) Assignee: Capsulab Ltd, Ramat Gan (IL)

(21) Appl. No.: 17/927,886

(22) PCT Filed: May 27, 2021
(86) PCT No.: PCT/IL2021/050635

§ 371 Date: Nov. 27, 2022

Related U.S. Application Data
(60) Provisional application No. 63/030,580, filed on May 27, 2020.

(51) Int. Cl. B01F 35/71; B01F 27/808; B01F 27/88; B01F 33/841; B01F 35/75; B01F 35/95

(52) U.S. Cl. CPC B01F 35/7174; B01F 27/808; B01F 27/88; B01F 33/841; B01F 35/7137; B01F 35/7164; B01F 35/754251; B01F 35/95; B01F 2035/99

(57) ABSTRACT

A capsule for mixing multiple substances, comprising: a main chamber having a main chamber bottom and a main chamber top, the main chamber top having a top opening; a main piston fitted in the main chamber; a torque adapter for transferring a torque from an external actuator to a mixer element via the main chamber bottom; and a cup shaped reservoir having a reservoir bottom which is having a bottom opening, wherein the reservoir bottom is fixated to the main chamber top such that the bottom opening is aligned with the top opening of the main chamber, so that fluid pushed by the main piston from the main chamber is passed through the top opening and the bottom opening and is accumulated in the cup shaped reservoir.

### RELATED APPLICATION/S

This application claims the benefit of priority of U.S. Provisional Patent Application No. 63/030,580 filed on 27 May 2020, the contents of which are incorporated herein by reference in their entirety.

This application is also related to PCT Patent Application No. PCT/IL2019/051276 filed 22 Nov. 2019 (Attorney Docket No. 79467), the contents of which are incorporated herein by reference in their entirety.

### FIELD AND BACKGROUND OF THE INVENTION

The present invention, in some embodiments thereof, relates to capsule, device and method for mixing multiple substances and, more particularly, but not exclusively, to selecting, mixing and preparing substances by consumers.

In recent years, consumers of toiletries, personal care, food additives, nutritional supplements and pharma, are expressing a growing need for custom-made, personalized, modular and/or do-it-yourself preparations of ingredients.

Existing solutions provide some devices and/or services for selecting, mixing and/or preparing ingredients into a preparation, mostly for use by specialists.

### SUMMARY OF THE INVENTION

According to an aspect of some embodiments of the present invention there is provided a capsule for mixing multiple substances, comprising: a main chamber having a main chamber bottom and a main chamber top, the main chamber top having a top opening; a main piston fitted in the main chamber; a torque adapter for transferring a torque from an external actuator to a mixer element via the main chamber bottom; and

a cup shaped reservoir having a reservoir bottom which is having a bottom opening, wherein the reservoir bottom is fixated to the main chamber top such that the bottom opening is aligned with the top opening of the main chamber, so that fluid pushed by the main piston from the main chamber is passed through the top opening and the bottom opening and is accumulated in the cup shaped reservoir.

Optionally, an outer shell of the main chamber and the cup shaped reservoir are parts of one solid element.

Optionally, the capsule further comprises a mixer rod having the mixer element disposed at a distal end and the torque adapter disposed at a proximal end, the mixer rod is fitted to pass along the main piston such that the mixer element is mounted in the main chamber between the main chamber top and a distal end of the main piston.

More optionally, the main chamber top opening is sealed by a membrane, and the mixer rod includes a sharp tip at the distal end to puncture the membrane.

More optionally, the main piston is displaceable between the main chamber bottom and the main chamber top along the axis of the mixer element.

Optionally, the capsule further comprises at least two repository tubular chambers, each: (1) adapted to contain substance, (2) mechanically connected to the main chamber and (3) having a repository tubular chamber bottom opening; and at least two passages, each fluidly connecting one of the at least two repository tubular chambers to the main chamber.

More optionally, the main piston is sealing the at least two passages in a distal position and opens the at least two passages when being moved along the main chamber to a proximal position.

More optionally, the at least two repository tubular chambers are peripheral to the main chamber.

More optionally, each of the at least two repository tubular outer openings is sealed by a repository tubular piston.

More optionally, each of the at least two repository tubular pistons is having a bottom surface which is pushed by one of at least one pushing rod, to extract a substance from a respective one of the at least two repository tubular chambers via a respective one of the at least two passages into the main chamber.

More optionally, at least one of the at least two repository tubular chambers is comprising a locking element which is pushing against an inner wall of the respective one of the at least two respective repository tubular chambers to prevent a respective one of the at least two repository tubular piston to move downward after being pushed by a respective one of at least two pushing rods.

More optionally, the external actuator which is connected to the torque adapter is pulling the mixer rod downward, so the mixer element is pushing the main piston to open the at least two passages.

Optionally, the bottom opening includes a single opening.

Optionally, the bottom opening includes a plurality of openings.

Optionally, the reservoir bottom is detachably fixated to the main chamber top.

Optionally, the reservoir bottom is permanently fixated to the main chamber top.

According to an aspect of some embodiments of the present invention there is provided a device for mixing multiple substances in a capsule, comprising: a fixture for a single capsule, the fixture having a rotation mechanism; at least one pushing rod, each adapted to push a repository tubular piston into one of a plurality of repository tubular chambers of the single capsule to extract a substance into a main camber of the capsule; and a torque element for holding a mixer rod of the capsule and adapted to rotate, pull and push the mixer rod along an axis of the mixer rod; wherein the rotation mechanism is rotating the capsule relative to the at least one pushing rod, to align different at least one of the plurality of repository tubular chambers with the at least one pushing rod.

Optionally, the device further comprises a controller adapted to identify a capsule in the fixture and control movements of the pushing rods and the torque arm sequentially during one mixing and delivering session.

More optionally, the controller is further adapted to align the angular position of the capsule by identifying at least one of a radio-frequency identification (RFID) chip and a barcode printed on the capsule, while the capsule is the capsule is rotated by the rotation mechanism.

Optionally, the device further comprises at least one motor operating the pushing rods and the torque element.

Optionally, the torque element includes a torque arm having a clamp for holding the mixer rod.

More optionally, the clamp is adapted for grabbing and releasing a torque adapter disposed at a proximal end of the mixer rod.

Optionally, the device further comprises at least one main pushing rod for pushing the main piston towards the main chamber top.

According to an aspect of some embodiments of the present invention there is provided a method mixing multiple substances in a capsule, comprising: fixing a capsule to a mixer device, the capsule comprising a main chamber having a main chamber bottom and a main chamber top, the main chamber top having a top opening; rotating a mixer rod of the capsule by an actuator of the mixer device, the mixer rod is fitted to pass along a main piston fitted in the main chamber, to operate a mixer element mounted at a distal end of the mixer rod and located inside the inner chamber. pushing the main piston towards the main chamber top to extract mixed substances from the main chamber top opening to be accumulated in a cup shaped reservoir of the capsule, the cup shaped reservoir having a reservoir bottom which is having a bottom opening, wherein the reservoir bottom is fixated to the main chamber top such that the bottom opening is aligned with the top opening of the main chamber.

Optionally, the method further comprises, after the fixing: pulling the mixer rod of the capsule, thus moving the main piston along the main chamber from a distal position wherein the main piston is sealing at least two passages each fluidly connecting at least two repository tubular chambers to the main chamber, to a proximal position to open the at least two passages.

Optionally, the method further comprises, after the pulling: pushing at least two repository tubular pistons fitted in the at least two repository tubular chambers to extract substances from the at least two repository tubular chambers via a respective one of the at least two passages into an inner chamber of the main chamber sealed by the main piston.

Optionally, the method further comprises: while rotating the mixer rod, pulling and pushing the mixer rod to move the mixer element inside the inner chamber.

Optionally, the method further comprises: puncturing a membrane sealing a main chamber top opening in the main chamber top via a sharp tip disposed at the distal end of the mixer rod.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1 and 2 are drawings of a capsule for mixing multiple substances, and an upturned view of the capsule, according to some embodiments of the present invention;

FIG. 3 is a cross section view of the capsule of FIG. 1, according to some embodiments of the present invention;

FIG. 4 is an upturned view of an inner part of the capsule of FIG. 1, according to some embodiments of the present invention;

FIG. 5 is a cross section view of a capsule having longer repository tubular chambers, according to some embodiments of the present invention;

FIGS. 6A and 6B are drawings of a front view and a cross section view, respectively, of a device for mixing multiple substances in a capsule, according to some embodiments of the present invention;

FIGS. 7A and 7B are drawings of the device of FIG. 6A with the capsule of FIG. 1, from different views, according to some embodiments of the present invention;

FIG. 8 is a flowchart schematically representing a method for mixing multiple substances in a capsule, according to some embodiments of the present invention;

FIGS. 9A, 9B, 9C, 9D, 9E, 9F, 9G, 9H, 9I, 9J, 9K, 9L and 9M are cross section drawings of device 200 with capsule 100, at different stages of the method of FIG. 8, according to some embodiments of the present invention;

FIGS. 10A and 10B, which are drawings of exemplary rotatable trays, according to some embodiments of the present invention;

FIGS. 11A and 11B, which are drawings of a capsule with an RFID chip at the bottom and on the side of the capsule, respectively, according to some embodiments of the present invention;

FIG. 12, which is a drawing of a capsule with a perimetric barcode, according to some embodiments of the present invention;

FIGS. 13A and 13B, which are side and top views of a capsule with an annular barcode, respectively, according to some embodiments of the present invention;

FIGS. 14A and 14B, which are side and top views of a capsule with an annular barcode covering the tubular chamber bottom openings, respectively, according to some embodiments of the present invention; and

FIGS. 15A and 15B are drawings of two exemplary locking elements, according to some embodiments of the present invention.

### DETAILED DESCRIPTION OF SPECIFIC EMBODIMENTS OF THE INVENTION

The present invention, in some embodiments thereof, relates to capsule, device and method for mixing multiple substances and, more particularly, but not exclusively, to selecting, mixing and preparing substances by consumers.

According to some embodiments of the present invention, there is provided a capsule for mixing multiple substances. The capsule includes a main chamber having a top opening and fixated to the main chamber is a cup shaped reservoir. The cup shaped reservoir has a bottom opening aligned with the top opening of the main chamber. Fluid in the main chamber is mixed by a mixer element, which is receiving torque from an external actuator via a torque adapter positioned at the main chamber bottom. After mixing, the fluid is pushed from the main chamber by a main piston fitted in the main chamber, and passed through the top opening of the main chamber and the bottom opening of cup shaped reservoir, and accumulating in the cup shaped reservoir.

The cup shaped reservoir which is part of the capsule, and has a fluid connection with the main chamber, prevents the need to use an external container for the mixed fluid when it is extracted from the main chamber.

The capsule also includes repository tubular chambers (tubes), each containing a substance and sealed by a repository tubular piston. Passages are fluidly connecting each repository tubular chambers to the main chamber. These passages are optionally sealed by a main piston fitted in the main chamber. The capsule also includes a mixer rod having the mixer element disposed at a distal end and the torque adapter disposed at a proximal end. The torque adapter is transferring a torque to the mixer element. The mixer rod is fitted to pass along the main piston such that the mixer element is mounted in an inner chamber of the main chamber sealed by the main piston.

The capsule is fixed to a mixing device. A torque arm of the device, having a clamp for holding a mixer rod, is pulling the mixer rod thus moving the main piston along the main chamber to a proximal position (downward) to open the passages. Substances may then be extracted from the repository tubular chambers into the main camber, which may be done by pushing the repository tubular pistons using one or more pushing rods of the device. The mixing device includes a rotation mechanism, which is rotating the capsule relative to the pushing rod, to align different repository tubular chambers with the pushing rod(s), so that substances may be extracted by the pushing rod(s). The torque arm rotates the mixer rod to operate the mixer element and mix the substances in the main chamber. One or more of the repository tubular chambers may include a locking element which is pushing against an inner wall of the repository tubular chamber to prevent the repository tubular piston from moving downward after being pushed by the pushing rod.

The design of the mixing device, with the rotation mechanism and the pushing rod(s) pushing from the bottom upward, allows a very compact size of the machine, since one or a few pushing rod(s) may be used for multiple repository tubular chambers. This also provides very accurate control of the amount of substance extracted from each repository tubular chamber into the main chamber, for example by 1 microliter.

Personalization of any type of preparation and/or customized mixture may be set-up by user preferences (manually or automatically by diagnosis) or may be set-up by an integrated diagnostic tool recommendation. For example, a capsule may contain 9 different raw substances that are stored separately and hermetically (for example 8 substances are stored in the repository tubular chambers and one substance is stored in the main chamber that may contain large volume of sealed basic ingredient). The final product that is produced may be any one of thousands of different final compositions of formulation, made from the same capsule.

Since the capsule provides hermetic storage and full separation between the ingredients with sealed tubes (prevention of exposure to oxygen nor light before use and between uses), many kinds of ingredients that are unstable and regularly may not be used in such preparations (since they are not functional and practically do not give any value), may be used effectively with capsule's fresh preparation. Users may personalize and determine mixture-ratios of any supportable mixable raw-materials (powder, liquid and gas).

Unlike pre-prepared mixtures, e.g. blocked ingredients, in which the exact ratios are undisclosed, formulation is transparent to customers and may be viewed (when applicable) on the capsule or by platform-application.

The capsule design supports a wide range of raw materials and ingredients, liquids, semisolids (gels), gases and solids (powders), some of which are potentially unstable or incompatible. For example, these ingredients are sensitive to oxidation (air), to light (photosensitive) or may react and/or alter solubility of each other.

The capsule design supports changeable quantities of raw materials inside each tube by the same capsule's mechanical structure and interface. It is also possible to partially fill in advance tubes with smaller quantities of ingredients. Capsule and device design supports flexible and changeable feed-tube dimensions (even without scale-up or scale-down considerations). The device allows preparation of small fresh batches (continuously) by mixing each time only part of each ingredient according to user's definition, and/or creation of different preparation types by selectively using only some of the ingredients. The device allows one-time preparation or multiple preparations per capsule. The design supports very accurate metered amount of dispensed preparation output as result of the capsule's main chamber and main piston that controls the precise quantity that is injected. Dispensing of preparation may be set in advance and may be stopped in the middle of the injection by the user.

Since the capsule contains all ingredients inside the tubes and not separately, there's no need for the user to manage ingredients separately and to level his supplies for specific optional formulas. Since the capsule contains an integral mixer inside and since the capsule is external to machine, there's no need of maintenance or cleaning of the device. The device may not require any setup by the user. The device may provide ready preparations within a very short time. Most of the mixture types may be ready within 30 to 60 seconds from turning on the device.

The preparations that may be made using the device include, for example, Toiletries—personal hygiene for washing and preventing unpleasant smells such as soap, shampoo, deodorants and perfumes, Personal care—for beautification use (skin care, hair care, cosmetics) and/or preparations for dermatology (derma-cosmetics), Food additives—such as substances added to food to preserve flavor or enhance its taste, appearance, or other qualities, Nutritional supplements—for example taken orally, and usually contains one or more dietary ingredients (vitamins, minerals, herbs, amino acids, and enzymes), Pharma—such as medications or drugs, homeopathy, oral care, or dental preparations and Drinks—such as a cocktail made from different alcoholic and/or non-alcoholic liquids.

For example, the device may be used to create hair dyes that are made in specifically selected colors and/or shades. A hair dye capsule may include ingredients in different colors that are sealed inside the repository tubular chambers of the capsule. According to the selected color, a specific amount of each ingredient is inserted into the main chamber to create the desired color. The device may be used at home by the end user to create a different color of hair dye according to the user's choice, or may be used for example at a hair salon, to provide a different color of hair dye for each costumer.

For another example, the device may be used to create personalized medication for a patient. A medication capsule may contain several active pharmaceutical ingredients (APIs) and/or supplements, each stored inside one of the repository tubular chambers of the capsule. A medication and/or a mix of medications mix may be prepared for a patient, based for example on specific physician prescription and/or real-time measurements of a patient's medical data. A mix with the right doses and combination of drugs may be prepared for a specific patient at a specific time, and may be optimized and/or modified accordingly, by adjusting the quantity extracted from each repository tubular chamber into the main chamber. This provides personalized, precise, on-demand medications, and/or a medication mix which is easier to take than multiple separate medications and may also improve adherence of patients.

For another example, the device may be used to create a preparation (such as a cream) from pre-formulation ingredients. Each of the repository tubular chambers of a capsule may contain one pure ingredient or a mix of ingredients and/or additives, which are only row materials and not formulations by themselves. When combined and mixed in the main chamber, the ingredients are turned into a formulation. For example, a water based ingredient and an oil based ingredient may be mixed to create a cream. In addition to modularity and personalization, this may reduce the required regulatory requirements, as the ingredients are not considered a formulation, such as cosmetic products, and potentially reduce cost.

Use of the device may provide solution to several needs of consumers. Users may want to have products that are self-prepared in real time, for example for reasons of freshness of preparations by mixing their ingredients just before use, minimizing the use of preservations and/or sensitive active raw materials that must be stored in sealed tubes with no contact with air/light for preventing oxidation or other instability reaction (for example antioxidants and/or vitamins). The capsule preserves chemical freshness by preventing instability on molecular level (molecular change), physical freshness by preventing phase separation (such as with oil & water), biological freshness by preventing active ingredient loss of activity, and microbiological freshness (vegan ingredients and/or saving preservatives) by preventing product contamination and microorganisms growth. Users may want to choose ingredients having specific characteristics, for example, vegan (doesn't contain any animal products and/or doesn't contain products that were tested on animals) and/or organic (certified by an authorized certification organization). Users may want to use products that have a “green” product life-cycle (no disposables). Users may want to have products that are custom made and/or personalized specifically for them. Users may want to control color, odor level, active ingredients ratios, sunscreens addition (and other personal care products) and/or any self-determined desired ratio of raw ingredients. Users may want to choose between available preparations formulas, define new formula for own use, use social network or the Internet to download a formula, use diagnostic tools with interface that support recommended formulas according to user's special needs (such as skin analysis by camera scan) and/or use artificial intelligence (AI) which may provide deeper level of formulas recommendations and deeper insights about the user's needs.

The application may provide the user with the ability to use other users' data, insights and recommendations of formulas and treatments' results that are shared in large scale through social media and web-based communities and/or to connect and exchange data, creating opportunities for more direct integration of the physical world to other users, resulting in efficiency improvements and economic benefits.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

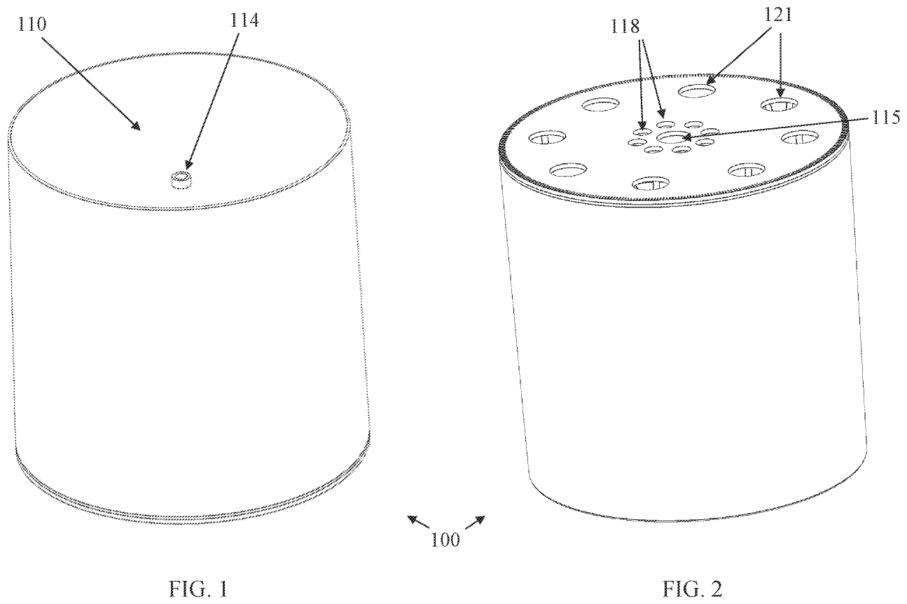

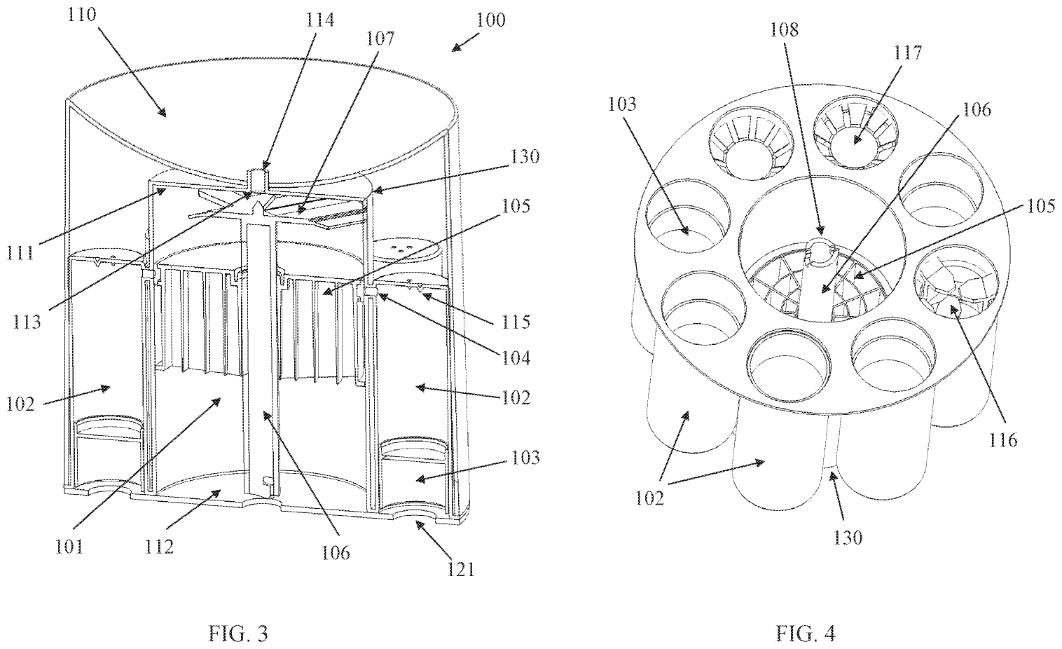

Referring now to the drawings, FIGS. 1 and 2 are drawings of a capsule for mixing multiple substances, and an upturned view of the capsule, according to some embodiments of the present invention. Reference is also made to FIG. 3, which is a cross section view of the capsule of FIG. 1, according to some embodiments of the present invention. Reference is also made to FIG. 4, which is an upturned view of an inner part of the capsule of FIG. 1, according to some embodiments of the present invention.

Capsule 100 comprises a main chamber 101 having a main chamber top 111 with a main chamber top opening 113, and a main chamber bottom 112.

Capsule 100 also comprises a cup shaped reservoir 110 having a reservoir bottom which is having a reservoir bottom opening 114. Cup shaped reservoir 110 may have any concaved shape, wherein the rim of the reservoir is higher than the center of the reservoir. The shape may include a substantially horizontal bottom and substantially vertical walls, or may include a gradual angle, for example at least 1 degree.

The reservoir bottom is fixated to the main chamber top 111 such that the reservoir bottom opening 114 is aligned with the main chamber top opening 113 and fluidly connecting main chamber 101 with cup shaped reservoir 110. The reservoir bottom opening 114 and/or the main chamber top opening 113 are sealed, for example by a membrane and/or any other seal. The reservoir bottom opening 114 and/or the main chamber top opening 113 may include a single opening, or may be comprised of multiple adjacent openings.

Cup shaped reservoir 110 may be detachably fixated to the main chamber top 111, or may be permanently fixated. For example, the Cup shaped reservoir 110 and main chamber 101 may be manufactured as one casted part.

Capsule 100 also comprises at least two repository tubular chambers 102, which are mechanically connected to main chamber 101, and each having a repository tubular chamber bottom opening 121. Optionally, repository tubular chambers 102 are peripheral to main chamber 101, each fluidly connected to main chamber 101 by one of passages 104.

Each of the repository tubular chambers 102 is adapted to contain a substance. The substance may be any kind of material used for preparation. The substance may be liquid or fluid such as cream, gel or syrup, may be oil based or water based, may be a stabilizer, surfactant or thickener, may include concentrated fluids, and/or may include flavors and/or pigments. The substance may be powder, for example solid ingredients that need a dry-storage before mixing them with liquids preparations or gas inhalers mixtures. The substance may also be gas. The substance may be a biological substance such as botanical or herbal (for example cannabis derived substances) or non-biological chemical substance.

Optionally, each of the repository tubular bottom openings 121 is sealed by a repository tubular piston 103. Repository tubular pistons 103, for example, may be used when the substance inside the repository tubular chamber is liquid or gas. Liquids and gases are easy to inject, so repository tubular piston 103 are simple and similar to syringe regular piston with high sealing-performances.

Each of the repository tubular chambers 102 is fluidly connected to main chamber 101 by a passage 104, from which substance may flow from the repository tubular chambers 102 to main chamber 101.

A main piston 105 is fitted in main chamber 101 and optionally sealing main chamber 101. Optionally, in a distal position, main piston 105 is sealing passages 104. When main piston 105 is moved along main chamber 101 to a proximal position (downward), passages 104 are open and substance may flow from the repository tubular chambers 102 to main chamber 101.

A mixer rod 106 is fitted to pass along main piston 105. Mixer rod 106 comprises a mixer element 107 disposed at a distal end, and a torque adapter 108 disposed at a proximal end. Torque adapter 108 is used for transferring a torque to mixer element 107. Mixer element 107 is mounted in main chamber 101 between main chamber top 111 and a distal end of main piston 105.

Mixer element 107 may be of any shape or type, structure and/or material, for example for different types of preparations. Optionally, the blades of mixer element include heating surfaces which are heating the preparation mixture in main chamber 101 while mixing.

Capsule 100 may be made of any material, for example, acrylic glass (methyl methacrylate), polyethylene terephthalate glycol, polypropylene, acrylonitrile styrene (acrylate), polystyrene, aluminum, acrylonitrile butadiene styrene, polyethylene, terephthalate, glass and/or any other material. Different preparations and different raw-ingredients require different storage materials, such as chemical resistant materials to acids or bases, bio-safe materials especially for medical and/or nutritional supplements preparations and/or antioxidants or vitamin that need an oxygen barrier to preserve stability. The mixing and preparing process may also require specific material characteristics, for example thermal resistance. Optionally, an internal part 130 of capsule 100 (not exposed to users), which comprises main chamber 101 and repository tubular chambers 102, may be produced from various materials according to ingredients' specifications and storage and/or mixing requirements. The structure of internal part 130 (and of capsule 100) may be designed to withstand internal forces without deformation, for example when viscosity of the substances is high or increased, for example during refrigeration.

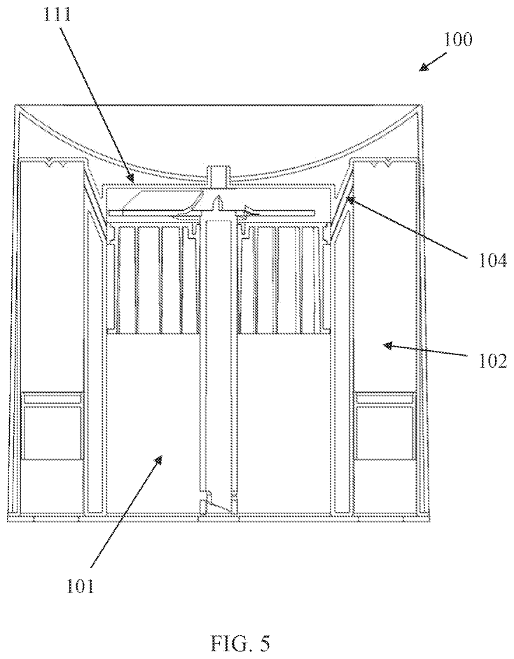

Reference is now made to FIG. 5, which is a cross section view of a capsule having longer repository tubular chambers, according to some embodiments of the present invention. Optionally, the repository tubular chambers 102 are longer than the main chamber 101, so the top of each of the repository tubular chambers 102 is higher than the main chamber top 111. In this case, the passages 104 are angled. This design may have the advantage of better using the space inside the capsule 100, and may also have some advantages in the process of manufacturing the capsule 100.

Capsule 100 is adapted to fit into a device 200, which holds capsule 100 and facilitates the mixing of substances.

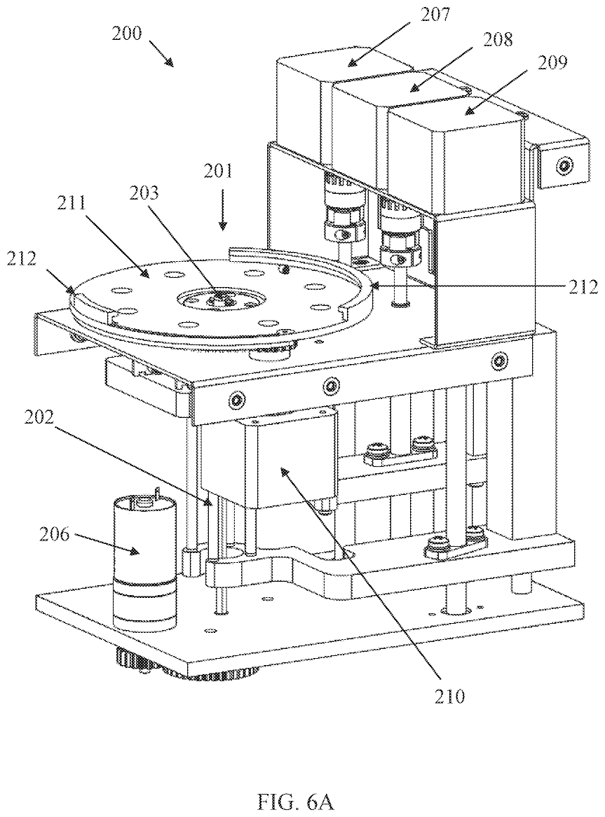

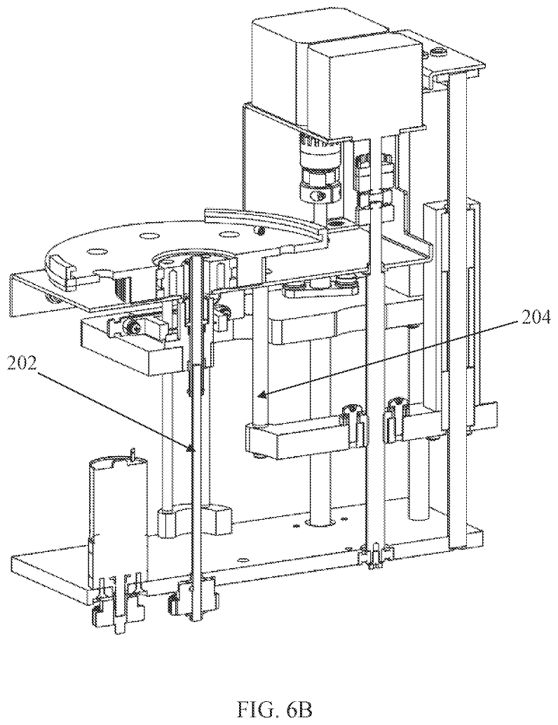

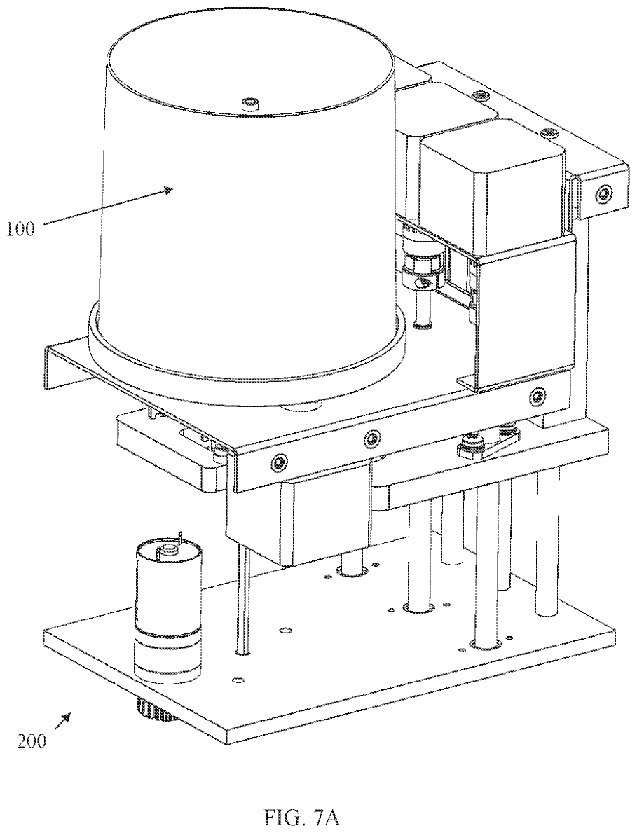

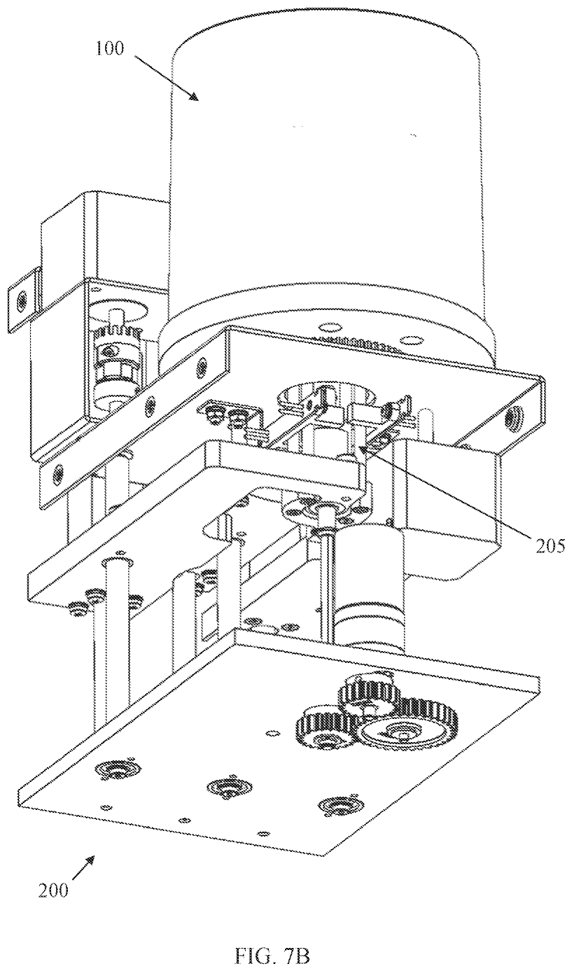

Reference is now made to FIGS. 6A and 6B, which are drawings of a front view and a cross section view, respectively, of a device for mixing multiple substances in a capsule, according to some embodiments of the present invention. Reference is also made to FIGS. 7A and 7B, which are drawings of the device of FIG. 6A with the capsule of FIG. 1, from different views, according to some embodiments of the present invention.

Device 200 includes a fixture 201 for a single capsule 100. Optionally, fixture 201 includes a rotation mechanism which is rotating the capsule relative to device 200, for example around a vertical axis. The rotation mechanism may comprise, for example, a rotatable tray 211 which is rotated by gears. Optionally, capsule 100 is attached to rotatable tray 211 by a screwing motion, so the rim of the capsule is sliding under and is held by protrusions 212. Other capsule attachments may include, for example, a quick release mechanism which locks the capsule for example by clips. Fixture 201 may fit to a capsule 100 of any size, for example according to the required quantities of substances and/or final mixed product.

Device 200 also includes a torque element, such as a torque arm 202 adapted to rotate, pull and push mixer rod 106 along an axis of mixer rod 106, by holding torque adapter 108. Torque arm 202 has a connector 203, such as a clamp, for holding torque adapter 108. Optionally, connector 203 is adapted for grabbing and releasing torque adapter 108. Optionally, torque arm 202 includes an actuator for pulling and pushing mixer rod 106, and/or a rotor for rotating mixer rod 106.

Optionally, device 200 includes at least one pushing rod, for example two pushing rods 204, each adapted to push a repository tubular piston 103 into a repository tubular chamber 102 to extract substance into main camber 101. Optionally, device 200 includes one or more main pushing rods 205, adapted to push the main piston 105.

Optionally, device 200 includes one or more motors operating pushing rods 204, main pushing rods 205, torque arm 202 and/or rotatable tray 211. Optionally, pushing rods 204, main pushing rods 205 and torque arm 202 are operated by separate motors. For example, torque motor 206 is operating the rotation of torque arm 202, arm motor 207 is operating the linear movement of torque arm 202, pushing rods motor 208 is operating pushing rods 204, main pushing rods motor 209 is operating main pushing rods 205, and rotation motor 210 is operating rotatable tray 211.

Device 200 also includes a controller adapted to identify a capsule 100 in fixture 201 and control movements of pushing rods 204, main pushing rods 205, torque arm 202 and/or rotatable tray 211, sequentially, during one mixing and delivering session. The operation of the different elements may be determined according to the capsule type, selected ingredients and amounts, user instructions and/or any other parameter.

The controller may include a processor which executes software that includes instructions for performing a method according to some embodiments of the present invention. The processor may include one or more processors arranged for parallel processing, such as clusters and/or as one or more multi core processor(s), and/or any other processing hardware. The controller may also include a communication module, which may connect via a network to a computing device operated by the user, such as a mobile phone. The user may provide instructions to the controller via a user interface of the computing device, for example by software application installed on the mobile phone. The user may select the properties of the desired mixture, the application and/or the controller calculate the correct movements of torque arm 202 and/or pushing rods 204 to create the desired mixture.

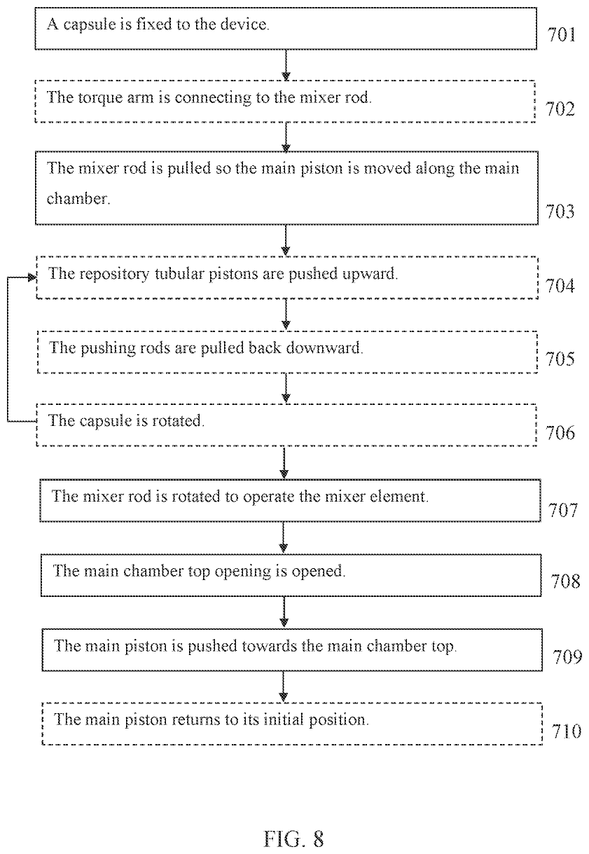

Reference is now made to FIG. 8, which is a flowchart schematically representing a method for mixing multiple substances in a capsule, according to some embodiments of the present invention.

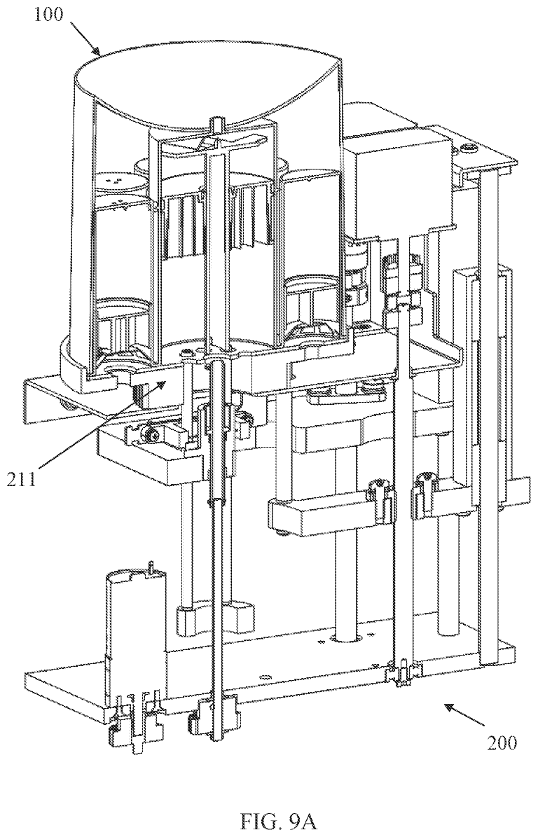

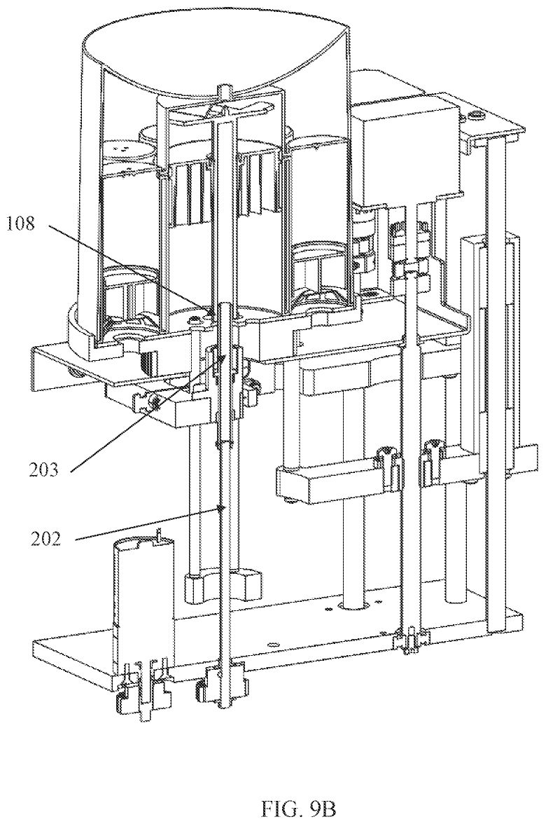

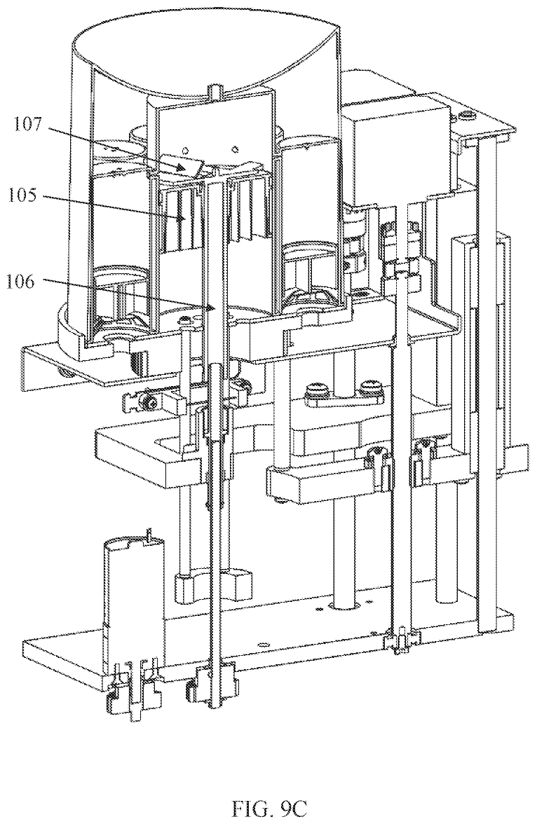

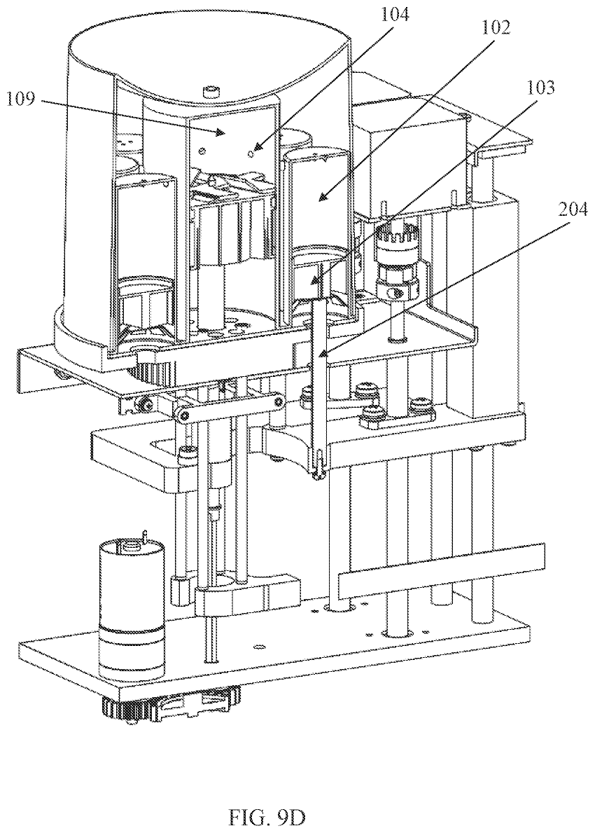

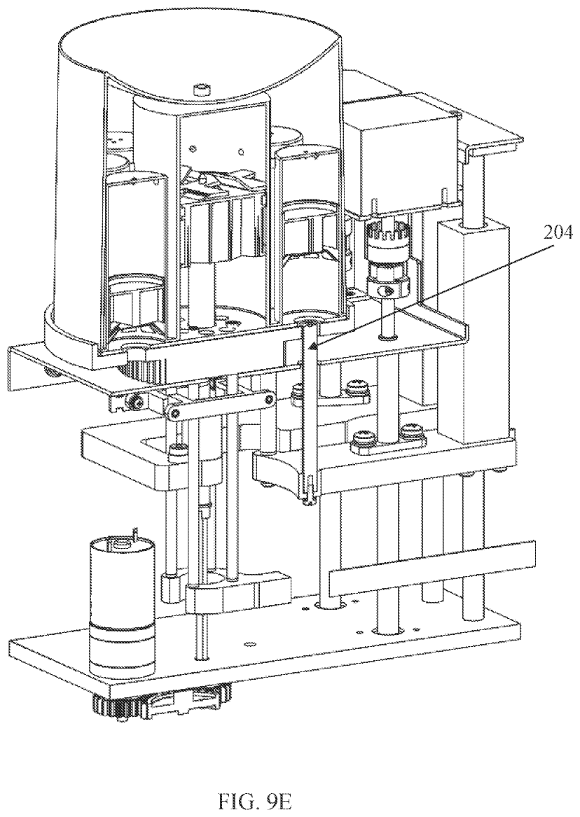

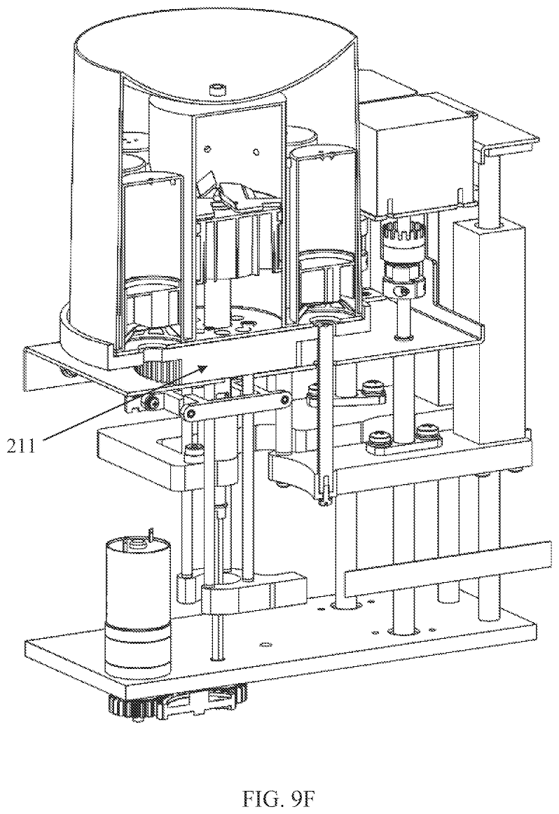

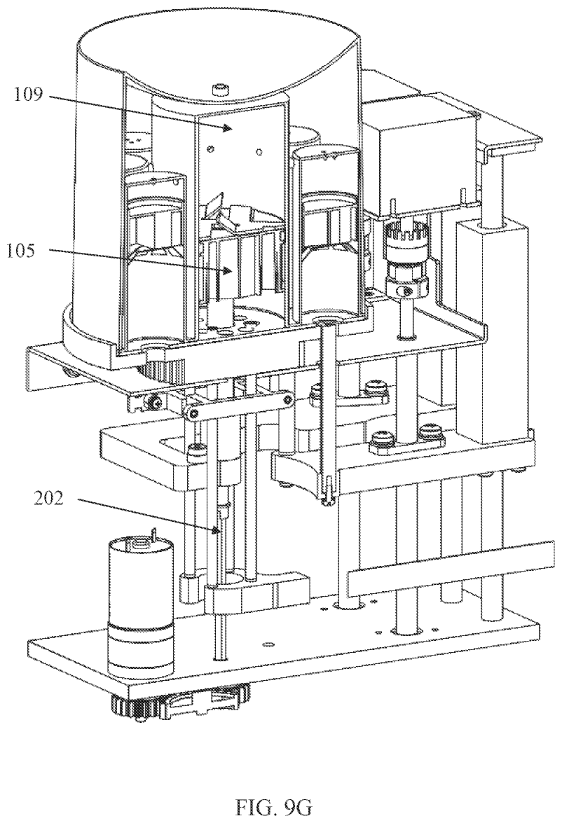

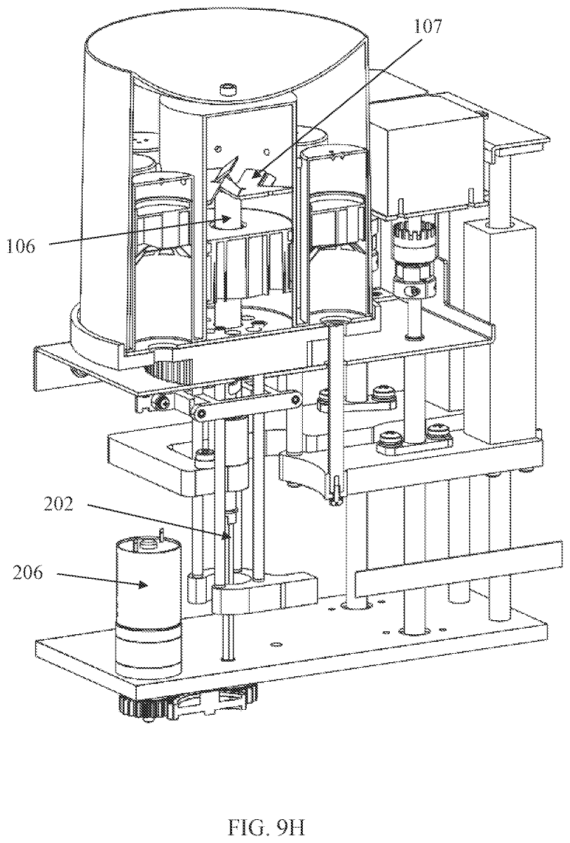

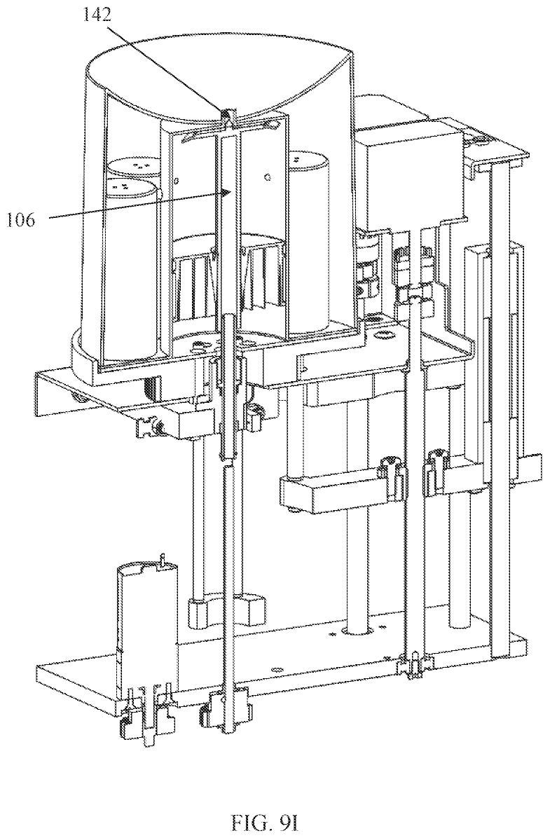

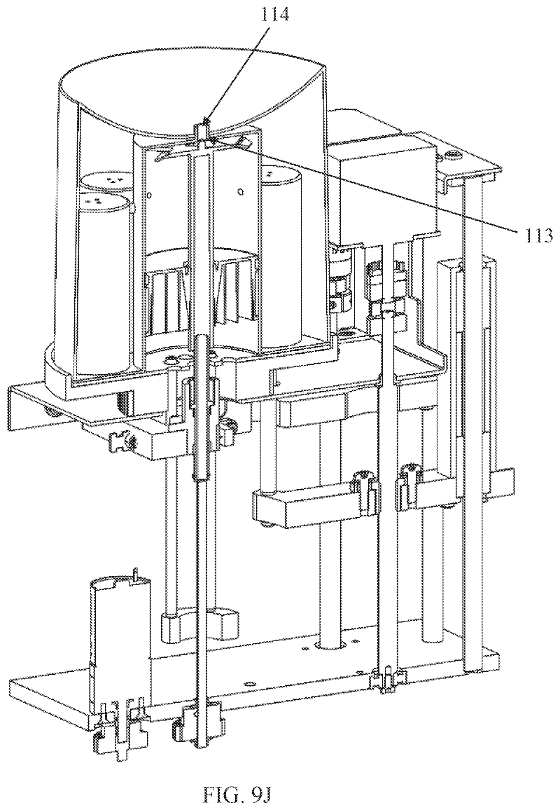

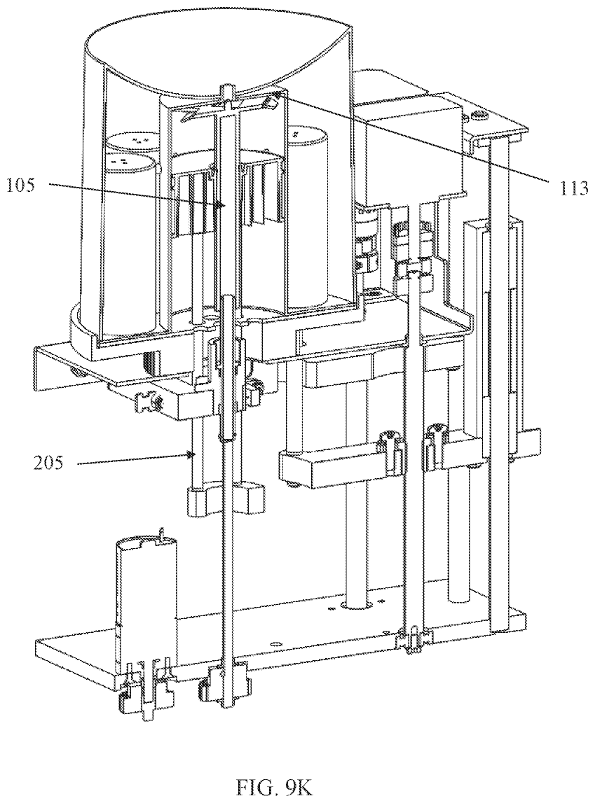

Reference is also made to FIGS. 9A, 9B, 9C, 9D, 9E, 9F, 9G, 9H, 9I, 9J, 9K, 9L and 9M, which are cross section drawings of device 200 with capsule 100, at different stages of the method of FIG. 8, according to some embodiments of the present invention.

First, as shown at 701 and FIG. 9A, a capsule 100 is fixed to device 200, for example by protrusions 212 of rotatable tray 211.

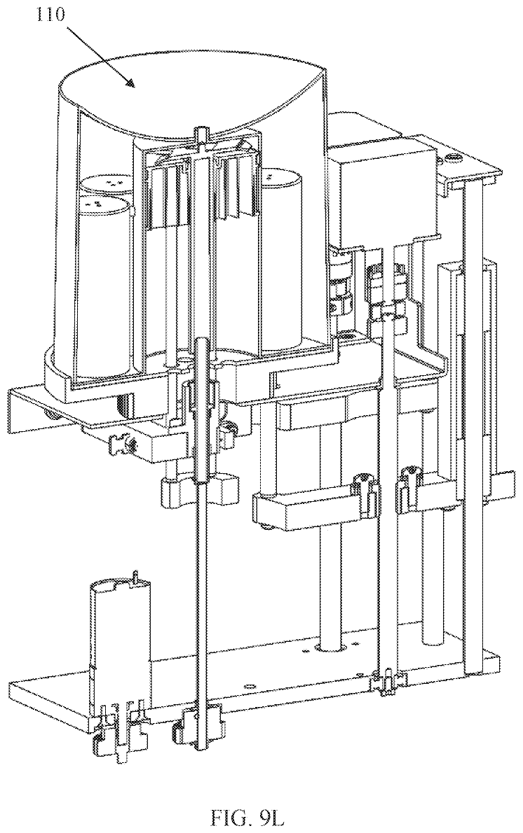

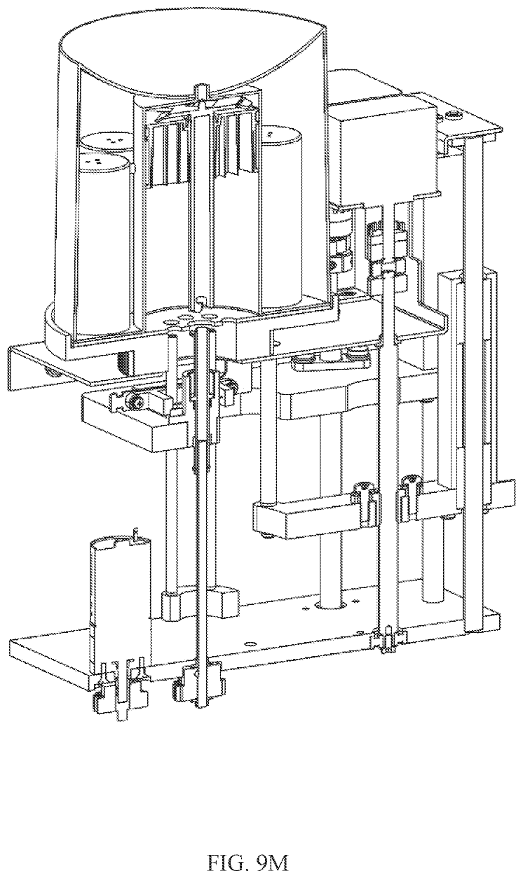

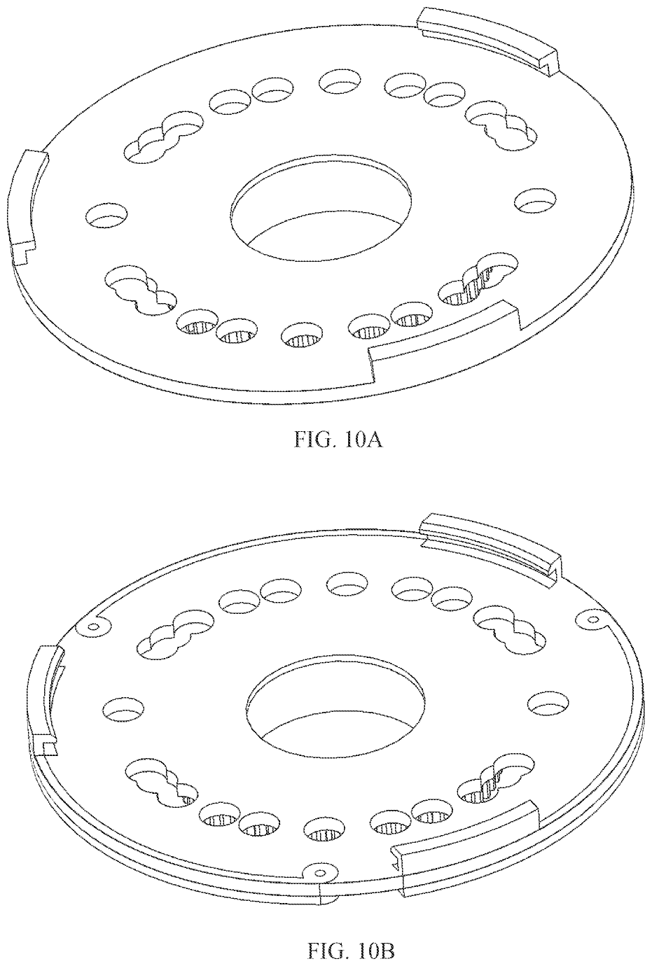

Reference is now made to FIGS. 10A and 10B, which are drawings of exemplary rotatable trays, according to some embodiments of the present invention. The rotatable tray of FIG. 10A includes protrusions for holding the rim of capsule 100. The capsule is rotated by the user and locked by the protrusions. The rotatable tray of FIG. 10A includes arms with protrusions for holding the rim of capsule 100. The capsule is positioned on the rotatable tray by the user and is locked by the arms closing on the rim of capsule. Optionally, the capsule fixed in fixture 201 is identified by the controller of device 200, for example by using radio-frequency identification (RFID) chip included in the capsule, and an RFID reader included in device 200. Reference is now made to FIGS. 11A and 11B, which are drawings of a capsule with an RFID chip 140 at the bottom and on the side of the capsule, respectively, according to some embodiments of the present invention.

Optionally or alternatively, the capsule fixed in tray 201 is identified by scanning a barcode printed on the capsule, such as a quick response (QR) code. This may be done, for example, by an imaging sensor included in device 200.

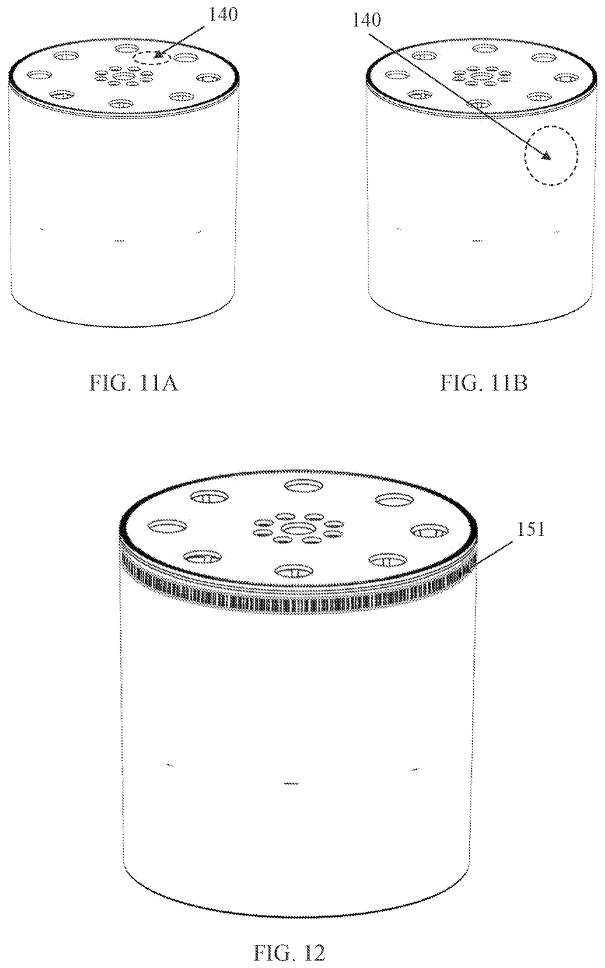

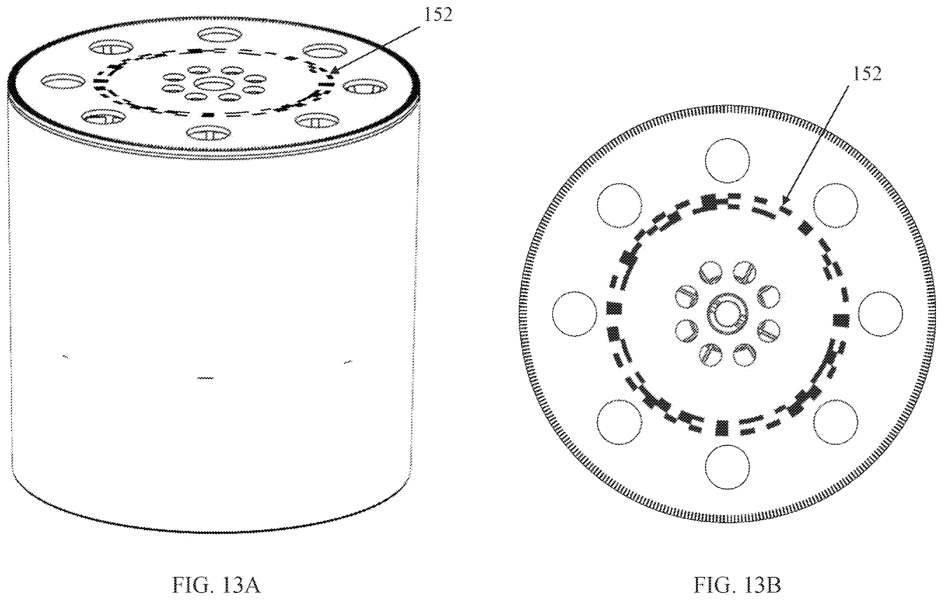

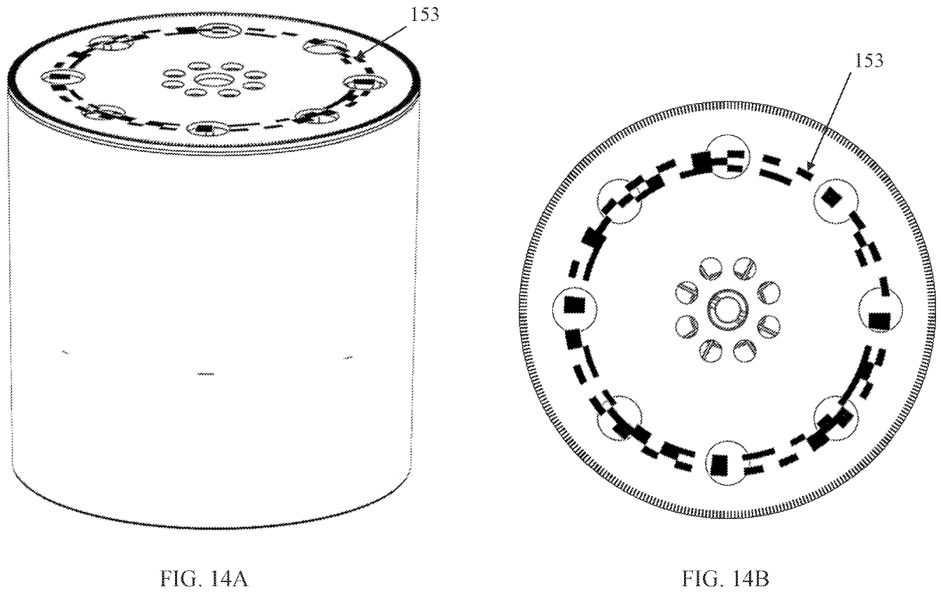

Optionally, the barcode is read by a single ray, while the capsule is rotated on rotatable tray 211. This has the advantage that a complex imaging sensor is not needed. Reference is now made to FIG. 12, which is a drawing of a capsule with a perimetric barcode 151, according to some embodiments of the present invention. Reference is also made to FIGS. 13A and 13B, which are side and top views of a capsule with an annular barcode 152, respectively, according to some embodiments of the present invention. Reference is also made to FIGS. 14A and 14B, which are side and top views of a capsule with an annular barcode 153 covering the tubular chamber bottom openings 121, respectively, according to some embodiments of the present invention. In this case, pushing rods 204 rip the barcode when pushed into repository tubular chambers 102, so the capsule may not be reused.

Optionally, the RFID chip and/or barcode are used by the controller for aligning the capsule with respect to the device 200. The capsule is rotated and is stopped at a specific angular position based on the location of the RFID chip and/or barcode, regardless of the initial position in which the capsule was positioned by the user.

Optionally, device 200 is adapted to fix capsules which are different from each other for example by length, physical structure, material, mixer element shape and/or other characteristics.

Optionally, device 200 is adapted to fix capsules of different chamber diameters. A capsule may have a small main chamber and small repository tubular chambers, a larger main chamber, and/or larger repository tubular chambers. For example, the main chamber may have a diameter between 30 millimeters (mm) and 80 mm, and the repository tubular chambers may have a diameter between 10 and 40 mm. Capsules of the same (or similar) total diameter may have different combinations of internal chamber diameters, so larger diameter of repository tubular chambers may result in smaller main chamber diameter.

Optionally, device 200 is adapted to fix capsules of different height. Longer (or shorter) length of repository tubular chambers and longer (or shorter) length of main chamber determines the general volume of the capsule, for example between volume of 15 milliliters (ml) to volume of 250 ml.

Optionally, device 200 is adapted to fix capsules having different number of repository tubular chambers and/or different diameters of openings. Capsules may have, for example, 6, 8, 10, 12 or any other number of repository tubular chambers.

Optionally, the capsule may have different initial filling states. Optionally, each repository tubular chamber is filled with a different substance. Optionally, ingredients are located inside the repository tubular chambers only, with no ingredients storage inside the main chamber (liquid nor powder) before capsule's first usage. Optionally, the repository tubular chambers are filled with substances and a main chamber partially filled with a different substance. In this case, the main chamber is for example full of liquid or base cream in advance. For example, the main chamber may be filled with substance which is crystalized when refrigerated (for example Vaseline based substance) and cannot move through the passages, but the crystallization is overturned when substance(s) from the repository tubular chamber(s) are added to the main chamber. For another example, the main chamber is filled with powder and optionally air in advance (for example active material or food-additive). When only part of the main chamber is filled with powder and the rest of it is free-space (air) there is no clamp caused by sub-pressure resistance, as described below. Optionally, one or more repository tubular chamber(s) are filled with substance, the main chamber partially is filled with the same substance, and other one or more repository tubular chamber(s) is filled with substance. Optionally, one or more of the passages are not sealed by the main piston, for example to prevent clamps caused by sub-pressure resistance.

Optionally, the capsule includes windows, for example located on repository tubular chambers 102 for external view of the ingredients before preparation, and/or located on main chamber 101 (for example on the capsule side and/or on the reservoir bottom) for external view of the mixing process. Optionally, the capsule includes a lighting element which is operating according to the status of the mixing process, to provide indication for the user.

Then, optionally, as shown at 702 and FIG. 9B, after capsule 100 is fixed to device 200, torque arm 202 is connecting to mixer rod 106. Torque arm 202 moves up so connector 203 is attached to torque adapter 108. Optionally, torque arm 202 passes through a main bottom opening 115 of main chamber bottom 112. The attachment may be done by any relevant mechanism. For example, pins of connector 203 are inserted into slots of torque adapter 108 and locked by rotation. For another example, connector 203 is a clamp which is attached to torque adapter 108 when torque arm 202 is moved up.

Then, optionally, as shown at 703 and FIG. 9C, mixer rod 106 is pulled (downward) so main piston 105 is moved along main chamber 101 from distal position to proximal position (downward). This movement opens passages 104, when they are sealed by main piston 105. Optionally, when mixer rod 106 is pulled, mixer element 107 is pushing main piston 105 downward.

Then, optionally, as shown at 704 and FIG. 9D, one or more of repository tubular pistons 103 (two in this example) are pushed upward by pushing rod(s) 204 to extract substances from repository tubular chamber(s) 102 via passage(s) 104 into an inner chamber 109 of main chamber 101 sealed by main piston 105.

When more than one, pushing rods 204 may push repository tubular pistons 103 simultaneously, or may push individually according to desired substances for example as defined by the user. In this case, pushing rods 204 are separately controlled by the controller.

Substances stored in repository tubular chambers 102 may be moved into main chamber 101 at different stages of the preparation process, and/or only selected substances and/or quantities of the substances stored in repository tubular chambers 102 may be moved into main chamber 101.

Optionally, torque arm 202 moves down, simultaneously to pushing rod(s) 204, to move main piston 105 downward, thereby enlarging inner chamber 109 to make room for substances from repository tubular chamber(s) 102.

Optionally, repository tubular chambers 102 and/or repository tubular pistons 103 include sharp tip(s), for example sharp tips 115 (shown in FIG. 3), for penetrating a substance bag located inside repository tubular chambers 102, when repository tubular pistons 103 are pushed. The substance bag allows better isolation of active materials, for example to prevent them from interacting with the material of the capsule during storage.

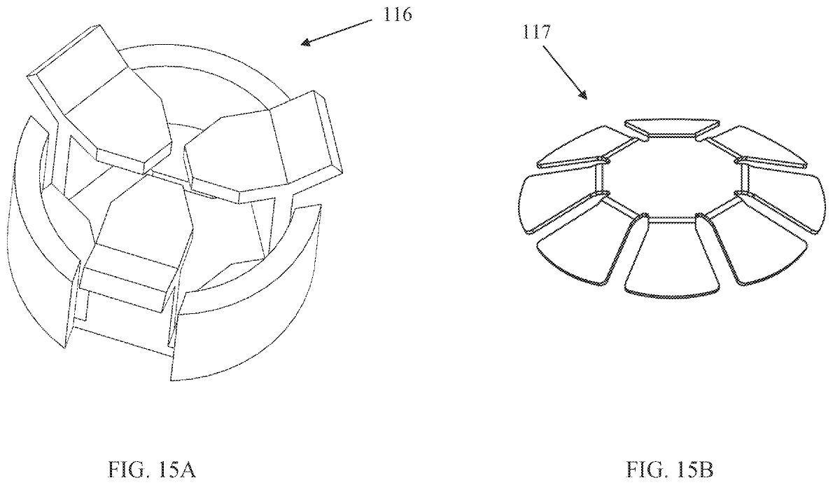

Optionally, repository tubular pistons 103 are held in position inside the repository tubular chambers 102, to prevent substance from main chamber 101 to return to the repository tubular chambers 102. This also prevents users from reuse of the capsule by refilling the repository tubular chambers 102. Repository tubular pistons 103 may be held, for example, by friction, by a spring, by locking teeth of repository tubular pistons 103 and/or by any other mechanism. Optionally, a locking element having locking teeth is included inside repository tubular chambers 102. Reference is now made to FIGS. 15A and 15B, which are drawings of two exemplary locking elements, according to some embodiments of the present invention. The locking elements 116 and 117 are also shown in FIG. 4, inside repository tubular chambers 102. Because of flexibility of outer locking teeth, the locking elements may be pushed further into the repository tubular chambers 102 by pushing rod(s) 204, together with repository tubular pistons 103. When pushing rod(s) 204 stop applying pressure, the locking teeth are pressing on an inner surface of the repository tubular chambers 102 and preventing a movement downward. Locking element 116 is made of plastic, while locking element 117 is made of metal so the locking teeth are penetrating the inner surface of the repository tubular chambers 102. Optionally, repository tubular chambers 102 include multiple notches at to stronger hold for the locking teeth.

Then, optionally, as shown at 705 and FIG. 9E, pushing rods 204 are pulled back downward and out of repository tubular chambers 102. Then, optionally, as shown at 706 and FIG. 8F, capsule 100 is rotated on rotatable tray 211 by motor 210, so two different repository tubular chambers 102 are positioned above pushing rods 204. Then, newly positioned repository tubular pistons 103 are pushed upward by pushing rods 204 to extract substances into inner chamber 109. The turning of rotatable tray 211 and subsequent pushing by pushing rods 204 may continue until all required substances are extracted into inner chamber 109.

Then, optionally, as shown at FIG. 9G, torque arm 202 moves down, moving main piston 105 into proximal position (down), to allow more space inside inner chamber 109 for the mixing stage.

Then, optionally, as shown at 707 and FIG. 9H, mixer rod 106 is rotated to operate mixer element 107. Mixer rod 106 is rotated by torque element 202 via connector 203. Torque arm 202 is rotated by motor 206. Optionally, while mixer rod 106 is rotated, mixer rod 106 is moved upward and downward by torque element 202, along the axis of mixer rod 106, to move mixer element 107 inside inner chamber 109.

Then, optionally, as shown at 708 and FIG. 9I, main chamber top opening 113 is opened to allow the mixture to exit from inner chamber 109. Optionally, mixer rod 106 is pushed upward so a sharp tip 142 of mixer rod 106, so a membrane sealing reservoir bottom opening 114 and/or main chamber top opening 113, is punctured by sharp tip 142. Sharp tip 142 may have any structure which allows it to puncture a membrane.

Then, optionally, as shown at FIG. 9J, mixer rod 106 is pulled downward so sharp tip 142 is out of reservoir bottom opening 114 and the main chamber top opening 113.

Then, optionally, as shown at 709 and at FIGS. 9K and 9L, main piston 105 is pushed upward to main chamber top 111, to extract the mixture (the mixed substances) from inner chamber 109 via main chamber top opening 113 and reservoir bottom opening 114 into cup shaped reservoir 110. Optionally, main piston 105 is pushed by main pushing rod(s) 205, for example via main pushing rod opening(s) 118.

Finally, optionally, as shown at 710 and FIG. 9M, mixer rod 106 is released from torque element 202 to allow removal of capsule 100. Optionally, before releasing mixer rod 106, main piston 105 is returned to its initial position and seals passages 104 (as shown at FIG. 8A) so ingredients remain clean and unexposed to air and other ingredients. This allows another mixing process to begin using the ingredients left in repository tubular chambers 102.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant capsules will be developed and the scope of the term capsule is intended to include all such new technologies a priori.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

In addition, any priority document(s) of this application is/are hereby incorporated herein by reference in its/their entirety.

1. A capsule for mixing multiple substances, comprising:
a main chamber having a main chamber bottom and a main chamber top, the main chamber top having a top opening;
a main piston fitted in the main chamber;
a torque adapter for transferring a torque from an external actuator to a mixer element via the main chamber bottom; and
a cup shaped reservoir having a reservoir bottom which is having a bottom opening, wherein the reservoir bottom is fixated to the main chamber top such that the bottom opening is aligned with the top opening of the main chamber, so that fluid pushed by the main piston from the main chamber is passed through the top opening and the bottom opening and is accumulated in the cup shaped reservoir;
at least two repository tubular chambers, each: (1) adapted to contain substance, (2) mechanically connected to the main chamber and (3) having a repository tubular chamber bottom opening; and
at least two passages, each fluidly connecting one of the at least two repository tubular chambers to the main chamber.

2. The capsule of claim 1, wherein an outer shell of the main chamber and the cup shaped reservoir are parts of one solid element.

3. The capsule of claim 1, further comprising:
a mixer rod having the mixer element disposed at a distal end and the torque adapter disposed at a proximal end, the mixer rod is fitted to pass along the main piston such that the mixer element is mounted in the main chamber between the main chamber top and a distal end of the main piston.

4. The capsule of claim 3, wherein the main chamber top opening is sealed by a membrane, and the mixer rod includes a sharp tip at the distal end to puncture the membrane.

5. The capsule of claim 3, wherein the main piston is displaceable between the main chamber bottom and the main chamber top along the axis of the mixer element.

6. (canceled)

7. The capsule of claim 1, wherein the main piston is sealing the at least two passages in a distal position and opens the at least two passages when being moved along the main chamber to a proximal position.

8. The capsule of claim 1, wherein the at least two repository tubular chambers are peripheral to the main chamber.

9. The capsule of claim 1, wherein each of the at least two repository tubular outer openings is sealed by a repository tubular piston.

10. The capsule of claim 9, wherein each of the at least two repository tubular pistons is having a bottom surface which is pushed by one of at least one pushing rod, to extract a substance from a respective one of the at least two repository tubular chambers via a respective one of the at least two passages into the main chamber.

11. The capsule of claim 10, wherein at least one of the at least two repository tubular chambers is comprising a locking element which is pushing against an inner wall of the respective one of the at least two respective repository tubular chambers to prevent a respective one of the at least two repository tubular piston to move downward after being pushed by a respective one of at least two pushing rods.

12. The capsule of claim 3, wherein the external actuator which is connected to the torque adapter is pulling the mixer rod downward, so the mixer element is pushing the main piston to open the at least two passages.

13. The capsule of claim 1, wherein the bottom opening includes a single opening.

14. The capsule of claim 1, wherein the bottom opening includes a plurality of openings.

15. The capsule of claim 1, wherein the reservoir bottom is detachably fixated to the main chamber top.

16. The capsule of claim 1, wherein the reservoir bottom is permanently fixated to the main chamber top.

17-23. (canceled)

24. A method for mixing multiple substances in a capsule, comprising:
fixing a capsule to a mixer device, the capsule comprising at least two repository tubular chambers and a main chamber having a main chamber bottom and a main chamber top, the main chamber top having a top opening;
rotating a mixer rod of the capsule by an actuator of the mixer device, the mixer rod is fitted to pass along a main piston fitted in the main chamber, to operate a mixer element mounted at a distal end of the mixer rod and located inside the inner chamber;
pushing at least two repository tubular pistons into at least two repository tubular chambers to extract from each of the at least two repository tubular chambers substance via a respective passage which fluidly connect between the respective repository tubular chamber and the main chamber; and
pushing the main piston towards the main chamber top to extract mixed substances from the main chamber top opening to be accumulated in a cup shaped reservoir of the capsule, the cup shaped reservoir having a reservoir bottom which is having a bottom opening, wherein the reservoir bottom is fixated to the main chamber top such that the bottom opening is aligned with the top opening of the main chamber.

25. The method of claim 24, further comprising, after the fixing:
pulling the mixer rod of the capsule, thus moving the main piston along the main chamber from a distal position wherein the main piston is sealing at least two passages each fluidly connecting at least two repository tubular chambers to the main chamber, to a proximal position to open the at least two passages.

26. The method of claim 25, further comprising, after the pulling:
pushing at least two repository tubular pistons fitted in the at least two repository tubular chambers to extract substances from the at least two repository tubular chambers via a respective one of the at least two passages into an inner chamber of the main chamber sealed by the main piston.

27. The method of claim 24, further comprising:
while rotating the mixer rod, pulling and pushing the mixer rod to move the mixer element inside the inner chamber.

28. The method of claim 24, further comprising:
puncturing a membrane sealing a main chamber top opening in the main chamber top via a sharp tip disposed at the distal end of the mixer rod.
